(19) United States
(12) Patent Application Publication
(10) Pub. No.: US 2005/0275347 A1
(43) Pub. Date: Dec. 15, 2005

(54) Double-shielded electroluminescent panel

(76) Inventors: Chih Ping Liang, Hsinchu (TW); Huei Pin Huang, Taoyuan (TW)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/058,606

(22) Filed: Feb. 16, 2005

(30) Foreign Application Priority Data
Jun. 9, 2004 (TW) 093209082

(51) Int. Cl. H05B 33/00; H05B 33/02

(52) U.S. Cl. 313/506; 313/512

(57) ABSTRACT

A double-shielded electroluminescent panel includes an electroluminescent device, an upper electrical shield and a lower electrical shield. The upper electrical shield is a transparent conductive material, and is overlaid on the illuminating surface of the electroluminescent device. The lower electrical shield is an electrical conductive material, and is mounted on the non-illuminating surface of the electroluminescent device. The upper electrical shield and lower electrical shield are together connected to the ground line of a power source. Therefore, the occurrence of electromagnetic interference and an electric shock is avoided.

### BACKGROUND OF THE INVENTION

1. Field of the Invention

The present invention relates to a double-shielded electroluminescent panel, more particularly to an electroluminescent panel against current leakage and electromagnetic interference.

2. Description of the Related Art

The great progress in electroluminescent device manufacturing has led to a rather large increase in the brightness of an electroluminescent device. In this regard, the electroluminescent device is capable of acting as the backlight source of a large-scale outdoor signboard such as a signboard with an area of from 60×90 cm² to 100×140 cm². Generally speaking, a user can control the operation voltage and alternating frequency of the electroluminescent device to change its brightness, wherein the range of the operation voltage is from 6V to 220V and the range of the alternating frequency is from 50 Hz to 1,500 Hz. The adjustment of the operation voltage or the alternating frequency controls the brightness or hue of luminescence. 140 V accompanied with 1,200 Hz is a currently popular driving specification for the driving power source of the electroluminescent device.

FIG. 1 is a schematic cross-sectional diagram of a conventional electroluminescent device. The electroluminescent device comprises an upper insulation layer 11, a front electrode layer 12, a fluorescence layer 13, a dielectric layer 14, a back electrode layer 15 and a lower insulation layer 16. The fluorescence layer 13 emits fluorescent rays through the upper insulation layer 11 after being excited by electrical energy. Therefore, the upper insulation layer 11 is the illuminating surface of the electroluminescent device 10. The front electrode layer 12 is made from a transparent ITO (Indium Tin Oxide) material, and the back electrode layer 15 is formed by coating or printing silver or carbon paste on the dielectric layer 14.

The electroluminescent device 10 applied to a large-scale signboard is generally fixed to the surface a metal plate or a metal frame. The metal plate is erected at an arresting place for public display. Because the environment moisture becomes higher or the dielectric coefficient of the lower insulation layer 16 is large enough, stray capacitors exist between the electroluminescent device 10 and the metal plate and result in current leakage.

FIG. 2 is an explanatory diagram illustrating current leakage and an electric shock occurring in the application of a conventional electroluminescent device. The electroluminescent device 10 is fixed to a metal plate 21, supplied with electrical power from an electrical source, and connected to an indoor socket 80 through an inverter 22. The common socket 80 includes three insertion holes respectively of a live line 81, a neutral line 82 and a ground line 83. In comparison with the socket 80, the inverter 22 has two plug terminals 221 and 222 connected to the neutral line 82 and live line 81, respectively. Because stray capacitors 231 exist between the electroluminescent device 10 and metal plate 21, electric charges accumulate on the surface of the metal plate 21. When a voltmeter is used to measure the voltage between the metal plate 21 and ground line 83, a considerable voltage difference exists between them. When a person touches the metal plate 21, he gets an electric shock caused by an electric current through his body. If the area of the electroluminescent device 10 is over 1,000 cm², the driving source of it is set to the specification of 140V and 1,200 Hz so the voltage between the metal 21 and ground line 83 is higher than 1,000V. Meanwhile, a stray capacitor 231 exists in the inverter 22, hence the person touching the metal plate 21 would be a part of the circuit loop.

The structure of the conventional electroluminescent device 10 is too simple to be free from the danger of an electric shock. U.S. Pat. Nos. 5,899,549 and 6,528,941 respectively disclose an electroluminescent device with a lower shield layer that protects the components attached to the backside of the electroluminescent device from electromagnetic interference.

The electroluminescent device is a planar light source, and can display a large-scale image. When the specification of the driving source is 140V and 1,200 Hz, numerous electromagnetic waves are radiated from the illuminating surface. In this regard, the operation environment of reduced electromagnetic radiation does not comply with this fact.

In summary, an electroluminescent combination is in an urgent need of avoiding current leakage for the electroluminescence market to overcome the aforesaid problems.

### SUMMARY OF THE INVENTION

The primary objective of the present invention is to provide a double-shielded electroluminescent panel. The leakage current is led to a ground or earth through its two electrical shield. Therefore, when a person touches the metal plate supporting the electroluminescent device, there is no danger of an electric shock due to the current passing through his body.

The second objective of the present invention is to provide an electroluminescent panel free from electromagnetic interference. The interference of exterior electromagnetic waves is isolated from the electroluminescent panel by two electrical shields. Furthermore, the electromagnetic radiation generated from the electroluminescent panel is also absorbed by the shields so as not to be emitted to the exterior.

In order to achieve the objective, the present invention discloses double-shielded electroluminescent panel. The double-shielded electroluminescent panel comprises an electroluminescent device, an upper electrical shield and a lower electrical shield. The upper electrical shield is a transparent conductive material, and is overlaid on the illuminating surface of the electroluminescent device. The lower electrical shield is an electrical conductive material, and is mounted on the non-illuminating surface of the electroluminescent device. The upper electrical shield and lower electrical shield are together connected to the ground line of a power source. Therefore, the occurrence of electromagnetic interference and an electric shock is avoided.

Moreover, a flexible buffer material is used to combine the lower electrical shield with the electroluminescent device to absorb the vibration generated from the electroluminescent device. Similarly, a flexible buffer adhesive is used to adhere the upper electrical shield to the electroluminescent device, hence the vibration behavior cannot transmit from the illuminating surface to the exterior.

### BRIEF DESCRIPTION OF THE DRAWINGS

The invention will be described according to the appended drawings in is which:

FIG. 1 is a schematic cross-sectional diagram of a conventional electroluminescent device;

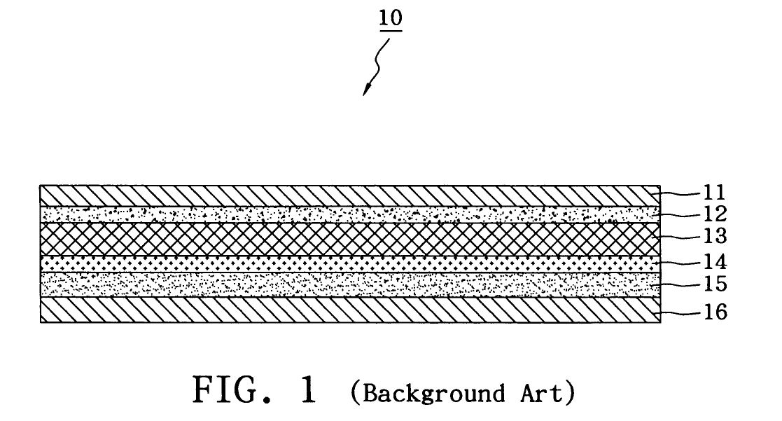

FIG. 2 is an explanatory diagram illustrating current leakage and an electric shock occurring in the application of a conventional electroluminescent device;

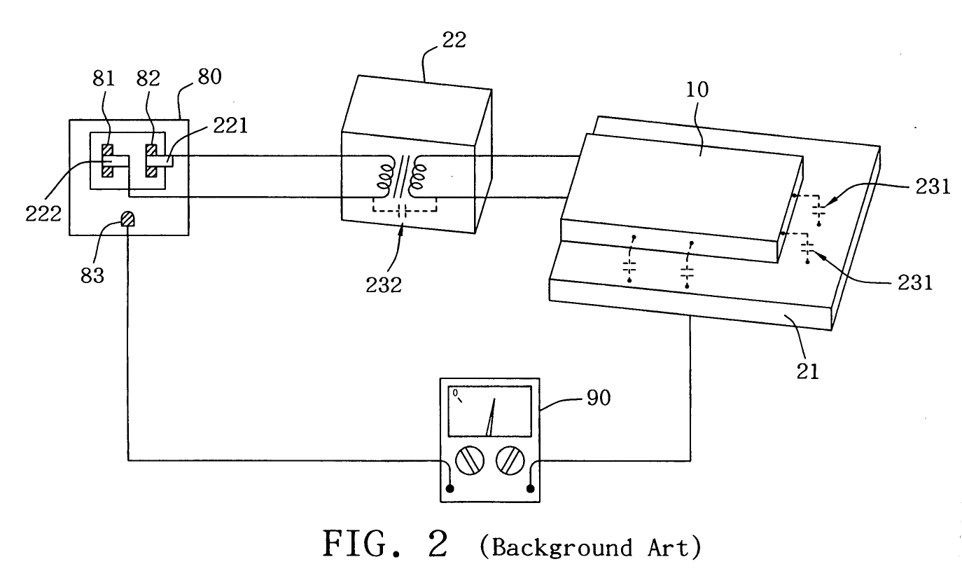

FIG. 3 is a schematic cross-sectional diagram of a double-shielded electroluminescent panel in accordance with present invention; and

FIG. 4 is an explanatory diagram illustrating the application of an electroluminescent panel against an electric shock and electromagnetic interference in accordance with the present invention.

### PREFERRED EMBODIMENT OF THE PRESENT INVENTION

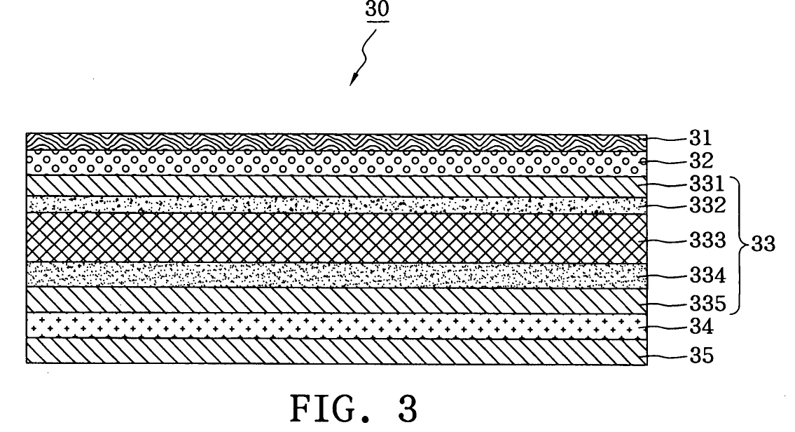

FIG. 3 is a schematic cross-sectional diagram of a double-shielded electroluminescent panel in accordance with present invention. The double-shielded electroluminescent panel 30 comprises an electroluminescent device 33, an upper electrical shield 32 and a lower electrical shield 34. The upper electrical shield 32 is a transparent conductive material such as ITO and an organic conductive high polymer, and is overlaid on the electroluminescent device 33. The lower electrical shield 34 is made from a conductive material such as a thin metal (aluminum, iron, etc.) plates and silver or carbon paste that is coated by printing on the non-illuminating surface of the electroluminescent device 33, wherein the non-illuminating surface is opposite to the illuminating surface.

The electroluminescent device 33 comprises an upper insulation layer 331, a front electrode layer 332, a fluorescence layer 333, a back electrode layer 334 and a lower insulation layer 335. The double-shielded electroluminescent panel 30 utilizes the upper insulation layer 331 to combine with the upper electrical shield 32, and the lower electrical shield 34 is also attached to it by the lower insulation layer 335. Furthermore, a transparent protection layer 31 is overlaid on the surface of the upper electrical shield 32 against any damage caused by scratches. Similarly, an insulator 35 covers the lower surface of the lower electrical shield 34 to allow it to withstand external force.

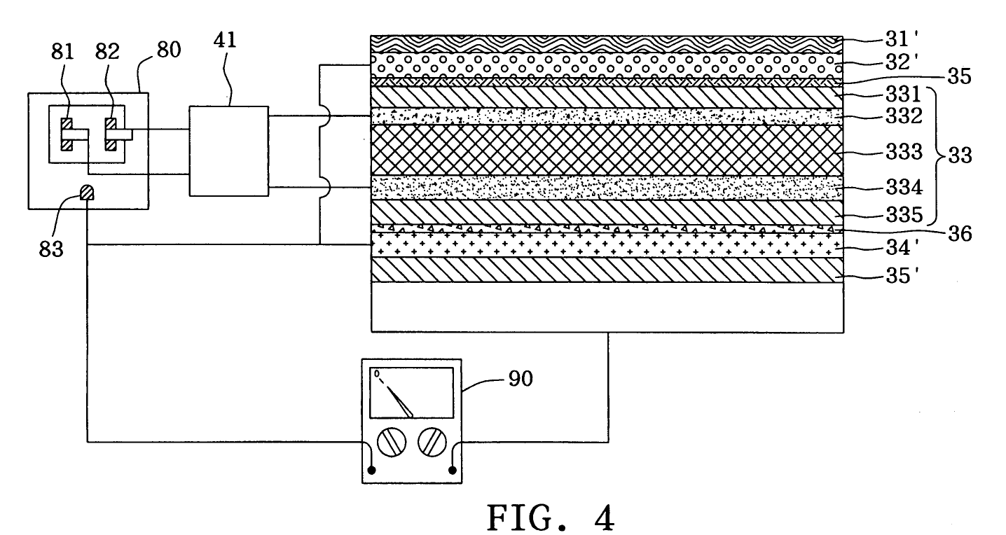

A dielectric layer (not shown) exists between the fluorescence layer 333 and back electrode layer 334. The dielectric layer is made from piezoelectric material such as BaTiO₃. When the electroluminescent device 33 supplied with electrical power starts to illuminate, the vibration behavior of the dielectric layer is induced by the stimulation of the electrical field. A flexible buffer adhesive 36 is used to combine the lower electrical shield 34′ with the electroluminescent device 33 to absorb the vibration generated from the electroluminescent device 33, as shown in FIG. 4. On the other hand, a similar flexible buffer adhesive 35 is used to adhere the upper electrical shield 32′ to the electroluminescent device 33, hence the mechanical waves cannot be transmitted from the illuminating surface to the exterior support frame. Instead of the flexible buffer adhesive 36, a sponge or a rubber coated with adhesive has the same shock absorption and connection function. For the sake of protecting the surfaces of the upper electrical shield 32 and lower electrical shield 34, a transparent protection layer 31′ and an insulator 35′ are also needed to cover the surfaces.

FIG. 4 is an explanatory diagram illustrating the application of an electroluminescent panel against an electric shock and electromagnetic interference in accordance with the present invention. The electroluminescent panel 30′ is fixed to a metal plate 42, and is supplied with electrical power from an electrical source, connected to an indoor socket 80, through an inverter 41. The inverter 41 has two plug terminals 411 and 412 connected to the neutral line 82 and live line 81, respectively. After the inversion, the live line 81 is connected to the front electrode layer 332 and back electrode layer 334. Furthermore, the upper electrical shield 32′ and lower electrical shield 34′ are together connected to the ground line 83 of the socket 80, hence electric charges accumulating on them is swiftly lead to the ground.

If the electroluminescent panel 30′ is applied to the body of a mobile vehicle, the upper electrical shield 32′ and lower electrical shield 34′ are together connected to its metal shell. Similarly, they are also coupled to the metal cover of a large-scale machine. When a voltmeter 90 is used to measure the voltage difference between the metal plate 42 and ground 83, the indication of it approaches zero. That is, when a person touches the metal plate 42, an electric shock caused from a leakage current or a discharge does not pass through his body.

On the other hand, because the upper electrical shield 32′ and lower electrical shield 34′ are together connected to the ground, they can absorb the electromagnetic radiation of the electroluminescent panel 30′ and isolate the electromagnetic interference from the exterior. In conclusion, the present invention not only protects operators and workers from an electric shock, but also has an anti-EMI (electromagnetic interference) function.

The above-described embodiments of the present invention are intended to be illustrative only. Numerous alternative embodiments may be devised by persons skilled in the art without departing from the scope of the following claims.

1. A double-shielded electroluminescent panel, comprising:
an upper electrical shield being a transparent conductive film with a contact grounded;
a lower electrical shield being a conductive film with a contact grounded; and
an electroluminescent device interposed between the upper electrical shield and the lower electrical shield, the electroluminescent device being capable of emitting luminescent rays through the upper electrical shield.

2. The double-shielded electroluminescent panel of claim 1, wherein the upper electrical shield and the lower electrical shield are together connected to a ground line of an electrical power source or grounded directly.

3. The double-shielded electroluminescent panel of claim 1, wherein the upper electrical shield and the lower electrical shield are together connected to a metal shell body of a vehicle or a large-scale machine.

4. The double-shielded electroluminescent panel of claim 1, wherein the lower electrical shield is a thin metal plate.

5. The double-shielded electroluminescent panel of claim 1, wherein the lower electrical shield is a silver paste layer or a carbon paste layer.

6. The double-shielded electroluminescent panel of claim 5, wherein the silver paste layer or the carbon paste layer is coated or printed on the electroluminescent device.

7. The double-shielded electroluminescent panel of claim 1, wherein the upper electrical shield is an ITO or an organic conductive high polymer.

8. The double-shielded electroluminescent panel of claim 1, further comprising a transparent protection layer overlaid on the upper electrical shield.

9. The double-shielded electroluminescent panel of claim 1, further comprising an isolator formed on the lower electrical shield.

10. The double-shielded electroluminescent panel of claim 1, further comprising a buffer interposed between the lower electrical shield and the electroluminescent device.

11. The double-shielded electroluminescent panel of claim 10, wherein the buffer is a sponge or a rubber.

12. The double-shielded electroluminescent panel of claim 10, wherein the buffer is a flexible adhesive.

13. The double-shielded electroluminescent panel of claim 1, further comprising a transparent buffer interposed between the upper electrical shield and the electroluminescent device.

14. The double-shielded electroluminescent panel of claim 13, wherein the buffer is a flexible adhesive.
